(19) United States
(12) Patent Application Publication
(10) Pub. No.: US 2005/0217736 A1
(43) Pub. Date: Oct. 6, 2005

(54) Hydrostatic displacer unit with a pivoting mechanism and a servo unit having pressure-reducing valves

(75) Inventor: Reinhardt Thoms, Neumunster (DE)

Correspondence Address: ZARLEY LAW FIRM P.L.C., CAPITAL SQUARE, 400 LOCUST, SUITE 200, DES MOINES, IA, 50309-2350, US

(73) Assignee: Sauer-Danfoss Inc., Ames, IA (US)

(21) Appl. No.: 11/089,104

(22) Filed: Mar. 24, 2005

(30) Foreign Application Priority Data
Apr. 2, 2004 (DE) 10 2004 016 368.5

(51) Int. Cl. F15B 13/044

(52) U.S. Cl. 137/596.17

(57) ABSTRACT

The invention relates to a hydrostatic displacer unit with a pivoting mechanism for two conveying directions for the continuous variation of the stroke of displacement pistons and with a servo system by means of which the pivoting mechanism can be moved in opposite pivoting directions. The servo system comprises at least two servocylinders, by means of which servopjstons which actuate the pivoting mechanism can be moved, and an adjusting device in each case with a pressure-reducing valve for each servocylinder. The control pistons of the pressure-reducing valves are coupled mechanically along a common axis of movement by means of a spring arrangement.

### BACKGROUND OF THE INVENTION

The invention relates to a hydrostatic displacer unit with a pivoting mechanism and a servo system having pressure-reducing valves according to the precharacterizing clause of Patent Claim 1.

Hydrostatic displacer units with a pivoting mechanism for two conveying directions for the continuous variation of the stroke of displacement pistons have devices by means of which the stroke volume can be varied in a controlled or regulated way. These devices are combined in all their subassemblies under the term “servo system”. So that, by means of the servo system, the pivoting mechanism can be moved in opposite directions and the volume flow can be varied accordingly, the servo system typically comprises at least two servocylinders which are each assigned a servopiston actuating the pivoting mechanism. The servo system may also be designed in such a way that a common servopiston movable in opposite directions is provided between two servocylinders arranged opposite one another.

The end faces of the servopistons form, together with the associated servocylinders, closed-off servo spaces which, by means of an adjusting device likewise belonging to the servo system, are alternately filled to a greater or lesser extent with hydraulic oil under a defined pressure and emptied again. Servopistons, which are in each case held in their desired initial position by means of spring force, are thereby shifted out of this neutral position. Since they are connected to the pivoting mechanism of the displacer unit, this brings about a corresponding variation in the stroke volume.

The adjusting unit of the servo system comprises in turn, in each case, an electrically activatable pressure-reducing valve for each servocylinder, each of the pressure-reducing valves acting on the assigned servo space via the axial adjustment of a control piston, so as to build up pressure or reduce pressure, and thus being responsible in each case for one of the two conveying directions.

Conventional servo systems having the described arrangement of servocylinders and servopistons, using electrically activatable pressure-reducing valves, are designed in such a way that the control pistons of the pressure-reducing valves in each case possess a specific spring for the return. Their control pistons are therefore first held in the initial position. Only when actuating forces which are high enough to overcome the spring prestress are applied to the control pistons are the control pistons shifted, with the result that control edges are opened or closed, so that a change of stroke volume in the displacer unit takes place via the variation of the pressures in the servo spaces.

Conventionally, the pressure-reducing valves in the servoadjusting unit act independently of one another and are arranged in such a way as to result in as simple as possible short connecting bores for hydraulic oil which is under relatively high pressure, for supplying the servo spaces with, if appropriate, reduced pressure and for the reduction of pressure in the servo spaces.

The disadvantage of this is that pressure-reducing valves even of the same type of construction are never identical because of unavoidable spring-force tolerances and fluctuations in the dimensions of the installation spaces. The result of this is that identical actuating forces lead, at different valves, to different conveying streams in each case.

Another disadvantage is that, conventionally, a sufficiently smooth transition from one conveying direction into the other cannot be implemented when the valves are operated independently of one another. Admittedly, what can be achieved by acting with pressure simultaneously upon oppositely acting servopistons, that is to say by the simultaneous actuation of two pressure-reducing valves with different actuating forces, is that the forces in the servo system for changing the stroke volume are cancelled to a greater or lesser extent, thus resulting in a smoother transition from one conveying direction into the other. As a rule, however, the action is not sufficiently symmetrical, because the response characteristics on both sides are simply too different.

A servo system of relevant hydrostatic adjusting devices having a servopiston guided in a pressure cylinder is described in DE 100 37 482 C1. This application does not say anything about an associated adjusting device supplying the servocylinders. This also applies to the publication DD 81787 which describes a hydrostatic axial-piston machine with a swashplate having an extension on which the servopistons adjusting the pivot angle are supported. The servopistons in this case act with respect to one another along a common axis of movement.

DE 198 42 029 A1 relates to a hydrostatic axial-piston machine with a regulating valve for adjusting the pivot angle of a swashplate. The control piston of the regulating valve is actuated by a stepping motor and is tensioned with respect to the latter and to a tappet supported on the swashplate at the opposite end of the control piston, in each case by means of a spring, the springs on both sides maintaining the equilibrium of forces between the individual elements.

The publication DE-A-24 56 381 discloses a device for regulating the delivery quantity of adjustable axial-piston pumps by means of a servo device and a master device supplying the servocylinders, the said master device controlling an auxiliary oil circuit via a control slide. The master device comprises two electromagnets which stand opposite one another along a common axis of movement and the tappets of which are supported on the control slide in each case via a spring. In the event of a shift by means of the electromagnets, the control slide respectively opens and closes the pressure and outflow lines leading to the servocylinders, with the result that the servopistons are shifted in the desired direction. A spring/lever system connecting the servopistons to the control slide serves for the necessary non-positive return to the master device and for regulating the set delivery quantity.

### SUMMARY OF THE INVENTION

By means of the invention, a hydrostatic displacer unit with a servo system is to be provided, which allows a smooth transition from one conveying direction into the other with a symmetrical activation characteristic.

The above-mentioned aim is achieved, in a hydrostatic displacer unit according to the precharacterizing clause of Patent Claim 1, in that the control pistons of the two pressure-reducing valves are coupled mechanically along a common axis of movement by means of a spring arrangement. A returnless proportional control can consequently be implemented, in which the stroke volume of the displacer unit is set essentially proportionally to the magnetic force or to the activating current of the magnets or to the pressure in the servo spaces which results from this. There is in this case no need for a mechanical return of the pivot angle of the displacer unit to the pressure-reducing valves.

According to the invention, the pressure-reducing valves are oriented, on the common axis of movement of their control pistons, in such a way that the actuating forces of the two valves which are exerted on the control pistons point in opposite directions. Between the two control pistons, a spring arrangement is provided, which is prestressed due to the predetermined construction space and, in the neutral position of the servo system, holds the control pistons in opposite directions in their initial positions against stops.

Advantageously, the servo system is designed in such a way that the control pistons of the pressure-reducing valves are pressed apart from one another in opposite directions along their common axis of movement by means of a compression-spring arrangement which comprises at least one compression spring. The actuating force exerted on the control pistons of one of the pressure-reducing valves standing opposite one another then presses the other control piston against its stop via the compression spring.

It is also possible, however, in a similar way to provide a tension-spring arrangement that comprises at least one tension spring, the control pistons then not being directed towards one another in the case of the compression spring, but, instead, pointing in opposite directions.

Preferably, the spring arrangement consists of a single spring. To generate a special force/travel characteristic, however, the spring arrangement may also comprise a plurality of springs arranged in series or in parallel.

Preferably, the pressure-reducing valves are designed as electrically activatable proportional pressure-reducing valves. In many instances, it is advantageous if the control pistons and the spring arrangement are arranged in a common housing. It is also possible, however, to use pressure-reducing valves which are produced in a cartridge type of construction and are fastened in a housing, in which case the spring arrangement is arranged between the control pistons guided in the cartridges.

In order to implement a special characteristic of the starting pressure, the preferred spring arrangement according to the invention comprises at least one spring, the spring winding of which is designed with a variable winding diameter in such a way that its force/travel characteristic is non-linear.

### BRIEF DESCRIPTION OF THE DRAWINGS

Further features and advantages of the invention may be gathered from the following FIGURE description.

FIG. 1 shows an adjusting device for the servo system of a hydrostatic displacer unit according to the invention.

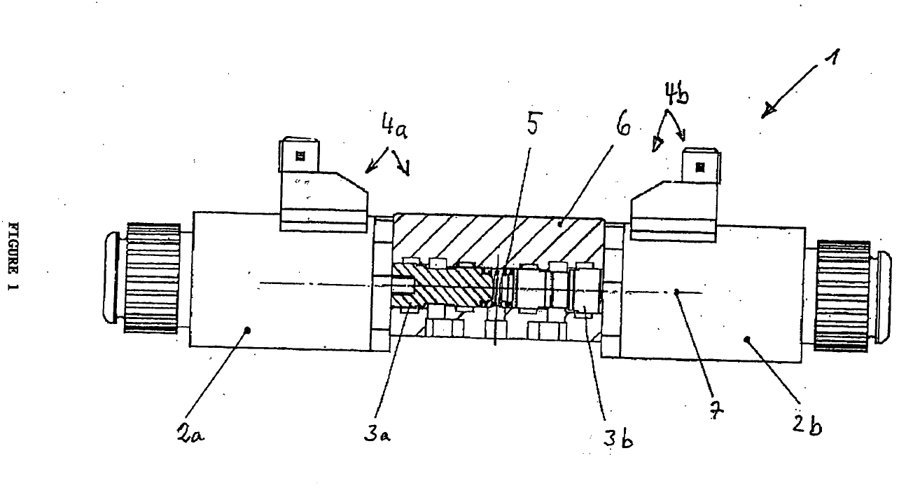

### DETAILED DESCRIPTION OF THE PREFERRED EMBODIMENT

The FIGURE illustrates an adjusting device 1 for the servo system of a hydrostatic displacer unit according to the invention. It consists in each case, for each conveying direction, of an electrically activatable proportional magnet 2a, 2b which, together with a control piston 3a, 3b in each case, forms an electrically activatable pressure-reducing valve 4a, 4b. The FIGURE in this case shows the control piston 3a in section, whilst the control piston 3b is illustrated non-sectionally.

The spring arrangement 5 consists, in the version according to the FIGURE, of a compression spring which is arranged between the ends of the control pistons 3a, 3b along their common axis of movement 7. The spring is prestressed by means of the available construction space and has the task of holding the control pistons 3a, 3b in their initial positions which are afforded on both sides in each case by a stop against which the respective control piston is pressed by the spring. When a sufficiently high actuating force is applied to one of the control pistons 3a, the spring 5 is compressed and the control piston 3a belonging to the activated pressure-reducing valve 4a is moved as a function of the ratio between the actuating force and the spring force, a corresponding pressure building up in the assigned servo space. The control piston 3b of the opposite pressure-reducing valve 4b is in this case pressed the more firmly against its stop by means of the rising spring force.

When, conversely, the same actuating force acts on the other pressure-reducing valve 4b, the shift of its control piston 3b is exactly the same, because the same forces then take effect. The change in stroke volume of the displacer unit is thus activated as far as possible or even completely symmetrically by the adjusting device.

In the exemplary embodiment depicted, the pressure-reducing valves 4a, 4b are used in what may be referred to as an opened-up type of construction. The control pistons 3a, 3b are in this case guided directly in a housing part 6 of the hydrostatic displacer unit. Alternatively, it is also possible to use complete pressure-reducing valves in a cartridge type of construction, which are inserted into the housing of the displacer unit and fastened there. In the latter case, the spring arrangement is arranged between the control pistons guided in the cartridges.

If different actuating forces are exerted simultaneously on the two opposite valves 4a, 4b, the servopressures emanating from the valves cancel one another exactly in the ratio of the actuating forces. This results in a smooth continuous transition from one conveying direction into the other.

A further advantage of the hydraulic displacer unit according to the invention and of the adjusting device described, over and above the implementation of a symmetrical activation characteristic for the two conveying directions, with a smooth transition between both of them, is that, where appropriate, malfunctions of one of the pressure-reducing valves can be eliminated by means of the actuation of the other valve in such a way that the second valve exerts a mechanical influence on the first valve.

1. Hydrostatic displacer unit with a pivoting mechanism for two conveying directions for the continuous variation of the stroke of displacement pistons and with a servo system by means of which the pivoting mechanism can be moved in opposite pivoting directions, the servo system comprising at least two servocylinders, by means of which servopistons which actuate the pivoting mechanism can be moved, and an adjusting device (1) in each case with a pressure-reducing valve (4a, 4b) being provided for each servocylinder, and each pressure-reducing valve (4a, 4b) in each case possessing a control piston (3a, 3b), characterized in that the control pistons (3a, 3b) are coupled mechanically along a common axis of movement (7) by means of a spring arrangement (5).

2. Hydrostatic displacer unit according to claim 1, characterized in that the actuating forces exerted on the control pistons (3a, 3b) of the pressure-reducing valves (4a, 4b) point in opposite directions.

3. Hydrostatic displacer unit according to claim 1, characterized in that, in the neutral position of the servo system, the spring arrangement holds the control pistons (3a, 3b) of the pressure-reducing valves (4a, 4b) in their initial positions against stops.

4. Hydrostatic displacer unit according to one of claim 1, characterized in that the spring arrangement (5) comprises at least one compression spring.

5. Hydrostatic displacer unit according to one of claim 1, characterized in that the spring arrangement (5) comprises at least one tension spring.

6. Hydrostatic displacer unit according to one of claim 1, characterized in that the spring arrangement (5) comprises a plurality of springs arranged in series or in parallel.

7. Hydrostatic displacer unit according to one of claim 1, characterized in that the pressure-reducing valves (4a, 4b) are designed as electrically activatable proportional pressure-reducing valves.

8. Hydrostatic displacer unit according to one of claim 1, characterized in that the control pistons (3a, 3b) and the spring arrangement (5) are arranged in a common housing part (6) of the hydrostatic displacer unit.

9. Hydrostatic displacer unit according to one of claim 1, characterized in that the pressure-reducing valves (4a, 4b) are produced in a cartridge type of construction and are fastened in the housing of the hydrostatic displacer unit, the spring arrangement being arranged between the control pistons (3a, 3b) guided in the cartridges.

10. Hydrostatic displacer unit according to one of claim 1, characterized in that the spring arrangement (5) comprises at least one spring, the spring winding of which is designed with a variable winding diameter, in such a way that its force/travel characteristic is non-linear.
